(19) United States
(12) Patent Application Publication
(10) Pub. No.: US 2003/0025389 A1
(43) Pub. Date: Feb. 6, 2003

(54) Control device for the braking system of a motor vehicle

(76) Inventors: Metin Ersoy, Walluf (DE); Waldemar Rogowski, Osnabruck (DE); Dieter Groger, Damme (DE)

Correspondence Address: McGlew and Tuttle, Scarborough Station, Scarborough, NY, 10510-0827, US

(21) Appl. No.: 10/168,769

(22) PCT Filed: Oct. 18, 2001
(86) PCT No.: PCT/DE01/03927

(30) Foreign Application Priority Data
Oct. 20, 2000 (DE) 100 52 290.4

(51) Int. Cl. B60T 8/44

(52) U.S. Cl. 303/114.3

(57) ABSTRACT

An actuating device for the brake system of a motor vehicle includes a pedal block (1) with a brake pedal (10) fixed thereon pivotably, with a brake booster (2) with a housing having a housing bottom part (6) and a housing bell (5) and with a master cylinder assembly unit (3) connected thereto for admitting hydraulic power into the individual wheel brakes of the motor vehicle. The pedal block (1) and the housing bottom part (6) are molded in one piece from a plastic. The said housing bell (5) and the master cylinder assembly unit (3) with reservoir (4) with a reservoir bottom (4a) and a piston unit (14) is molded as a one-piece plastic part. A hydraulic tube (15) jacketed by the plastic part for receiving the said individual brake pistons (17) is arranged within the piston unit (14).

### FIELD OF THE INVENTION

The present invention pertains to an actuating device for the brake system of a motor vehicle with a pedal block with a brake pedal fixed to it pivotably, with a brake booster with a two-part housing and with a master brake cylinder assembly unit connected thereto for admitting hydraulic power to the individual wheel brakes of the motor vehicle.

### BACKGROUND OF THE INVENTION

Various designs of such actuating devices have been known in the state of the art and are used, in principle, in any motor vehicle. The design of the individual components of the actuating device differs in terms of the size and shape as well as in regard to additional attached parts, but there are also fundamental agreements in the individual components. Thus, the brake booster housing is made of steel plate for reasons of strength and is flanged to the pedal block, which is likewise made of metal in most cases, during the assembly of the actuating device. The master cylinder assembly unit, which comprises a master cylinder housing with inner components and a reservoir for the hydraulic brake fluid, is screwed on the front side of the brake booster facing away from the pedal block. The master cylinder housing is, in general, a machined metal casting. Attached parts that are additionally necessary for the operation of the entire actuating device, e.g., end switches, actuating cables, restoring springs or mounting components, are mounted individually on the entire assembly unit.

Both the selection of the material and the design of the individual assembly units, as well as the usually separate shipping of parts by brake vendors and, e.g., manufacturers of the pedal mechanism, lead to a great manufacturing and assembly effort and, as a result of this, to high costs. It is moreover also difficult to achieve the reduction of the depth of manufacture for individual motor vehicle assembly units, which is frequently desirable in the automotive industry.

GB 2 235 026 A discloses an assembled module comprising a brake booster and a brake pedal, wherein the rear wall of the brake booster and the holding means for the brake pedal are molded in one piece from a plastic. The master cylinder is arranged at the brake booster, and a push rod for actuating the brake system is secured at the brake pedal. A clutch pedal and a gas pedal may also be secured at the holding means beside the brake pedal.

GB 2 235 263 A discloses an assembled module comprising a brake booster and a brake pedal, wherein the rear wall of the brake booster and the holding means for the brake pedal are molded in one piece from a plastic. The master cylinder is arranged at the brake booster, and a push rod for actuating the brake system is secured at the brake pedal. The brake booster and the brake pedal are assembled to a single unit before the installation in the motor vehicle. A clutch pedal and a gas pedal may also be secured at the holding means beside the brake pedal.

DE 93 15 502 U1 discloses a pedal, which is preferably combined with a piston guided displaceably in a master cylinder for actuating a motor vehicle clutch. The pedal is mounted pivotably in a pedal block and is connected to a piston rod of the piston. The master cylinder made mostly of plastic is pivotable, and the piston rod and a housing guiding the piston rod are mounted pivotably.

### SUMMARY OF THE INVENTION

The technical object of the present invention is therefore to provide a design of an actuating device for the brake system of a motor vehicle such that both the production costs and the assembly dimensions can be reduced. In addition, an actuating device of the type according to the present invention should make it possible to considerably reduce the depth of manufacture in order to meet the needs of modem automobile manufacture with respect to modular design.

The actuating device according to the present invention for the brake system of a motor vehicle has a pedal block with a brake pedal fixed thereto pivotably, with a brake booster with a housing comprising a housing bottom part and a housing bell, and a master cylinder assembly unit connected thereto for admitting hydraulic power to the individual wheel brakes of the motor vehicle. The pedal block and the housing bottom part are molded in one piece from a plastic. Furthermore, the housing bell and the master cylinder assembly unit having a reservoir with a reservoir bottom and a piston unit are molded as a one-piece plastic part, with a hydraulic tube jacketed by the plastic part being arranged within the piston unit for accommodating the individual brake pistons.

The pedal block and the brake booster housing bottom part facing the pedal block are molded in one piece from a plastic in the actuating device according to the present invention. Furthermore, the connected master cylinder assembly unit with the reservoir and the piston unit is integrated in the plastic part.

The union of the brake booster housing with the pedal block offers decisive advantages over the current prior art in several respects. On the one hand, components that are additionally necessary and their mounts can be integrated in the pedal block-brake booster housing module in a very simple manner and at low cost to a far greater extent because of the plastic material than in the case of the sheet metal design provided hitherto. An assembly unit that is extremely compact as a whole and can be additionally complemented due to the fact that both the part formed from the housing bottom part and the pedal block and the part formed from the housing bell and the master cylinder assembly unit are designed as injection-molded plastic parts. An assembly unit which can be completely pre-assembled and leads to a reduction in the number of individual parts, lower costs and, due to the large amount of plastic material used, to a substantial weight reduction is obtained due to this design. Moreover, the entire assembly unit can be pre-assembled and tested independently from the vehicle, so that the entire actuating device only needs to be fastened on the firewall of the corresponding motor vehicle and the brake lines must be connected to the individual wheel brakes of the motor vehicle during the final assembly proper of the motor vehicle.

It proved to be particularly advantageous for a hydraulic tube jacketed by the plastic part for accommodating the piston of the master cylinder piston to be arranged according to the present invention within the piston unit of the master cylinder assembly unit. This design ensures the reliable function of the master cylinder as well as a correspondingly long service life. If, furthermore, the plastic part is designed as an injection-molded plastic part, the injection molding of the hydraulic tube into the plastic part of the actuating device according to the present invention results in a very inexpensive manufacture. The design of the actuating device according to the present invention can, moreover, be made even more inexpensive if a common mounting element is provided at the pedal block for mounting both the brake pedal and an additional clutch and/or gas pedal. The individual mounts with their individual parts, which are common in the prior art, as well as costs necessary for mounting the individual pedals, are eliminated due to this measure.

Furthermore, it proved to be advantageous that the pedal block has contactless sensors, e.g., Hall sensors or inductive sensors for signal pick-up for the angular position of the brake pedal and additional clutch or gas pedal, the signal being transmitted to downstream evaluating assembly units of a motor vehicle electronic system by a central plug assembly unit. The contactless (Hall) sensors operate without rebound and wear, can be set electronically, and lead to a further functional integration of the entire actuating device, and the final testing of the entire module is further simplified.

In addition, the feel of actuation for the pivoting of the individual pedals can be improved by the pedal block having one or more control cams, on which a spring-loaded roller rigidly connected to the brake pedal and/or to the clutch and gas pedal rolls during the pivoting of the pedals.

The manufacture of the brake booster housing from plastic makes it, furthermore, possible to integrate supply lines for admitting vacuum or ambient pressure into the interior space of the brake booster housing in the housing wall of the brake booster housing. This measure leads to a further reduction in the assembly effort especially in the case of two-stage brake boosters (tandem brake boosters).

Two exemplary embodiments of the subject of the present invention will be explained in greater detail below on the basis of the drawings attached.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a lateral sectional view of a first exemplary embodiment of the actuating device according to the present invention for the brake system of a motor vehicle;

FIG. 2 is an end view of the actuating device from FIG. 1 from the side facing the passenger cell; and

FIG. 3 is a lateral sectional view showing a second embodiment variant of the subject of the present invention.

### DESCRIPTION OF THE PREFERRED EMBODIMENTS

Referring to the drawings in particular, the actuating device for the brake system of a motor vehicle has a pedal block 1, a brake booster 2 as well as a master cylinder assembly unit 3 provided with a reservoir 4. A plurality of brake lines for admitting hydraulic pressure to the individual wheel brakes, which are not shown specifically in the drawings for clarity's sake, are connected to the master cylinder assembly unit 3.

The brake booster 2 comprises essentially a housing bell 5 and a housing bottom part 6, which together define an interior space divided by a piston 7 into two partial areas in this exemplary embodiment.

A bracket 8, which juts forward and carries a common mounting element 9 for the pivotable mounting of a brake pedal 10 and a clutch pedal 11, is arranged at the pedal block 1. The pedal block 1 itself can be fixed with a plurality of screws that can be passed through the through holes 13 at a firewall of a motor vehicle, which firewall is not shown. The pedal block 1, the housing bottom part 7 and the housing bell 5 are designed as injection-molded plastic parts, the pedal block 1 and the housing bottom part 6 forming a common assembly unit.

Due to this special design, the entire actuating device has an extremely compact form, which leads to a shortening of the length of the entire module from the master cylinder assembly unit to the brake pedal by approx. 15% or, in absolute terms, by about 60 mm compared with the actuating device known from the prior art.

In addition to the design of the brake booster housing 5, 6 and the pedal block 1, the piston unit 14 belonging to the master cylinder assembly unit 3 is also designed as a one-piece injection-molded plastic part together with the housing bell 5, the injection-molded plastic part of the piston unit 14 also comprising the reservoir 4 of the master cylinder assembly unit 3.

A hydraulic tube 15, which accommodates the brake pistons 17, 18 for admitting hydraulic pressure to the individual wheel brakes in an inner through hole 16, is integrated in the injection-molded plastic part within the piston unit 14. The connection between the master cylinder assembly unit 3, the brake booster 2 and the pivotable brake pedal 10 is brought about by a push rod 19. The push rod 19 is connected to the brake pedal 10 by a bolt 20, which is displaceably accommodated in an elongated hole 21 of the brake pedal 10. This special connection between the push rod 19 and the brake pedal 10 is made possible by a straight guide 22 of the push rod 19, which leads to a further reduction in the overall length of the actuating device.

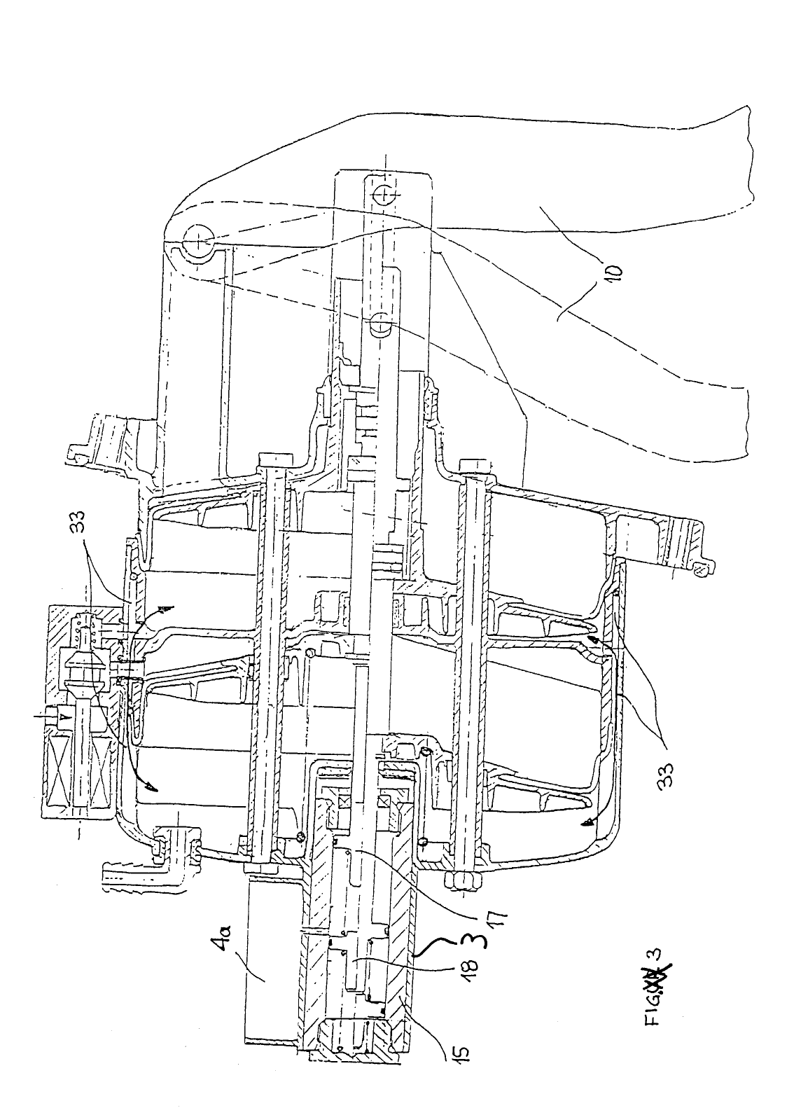

The reduction in the overall length makes possible the use of a tandem brake booster, as is shown in FIG. 3, along with the utilization of the entire installation space, instead of a conventional one-stage variant, which in turn reduces the supporting forces during the actuation of the brake pedal and facilitates the operation of the brake system for the user.

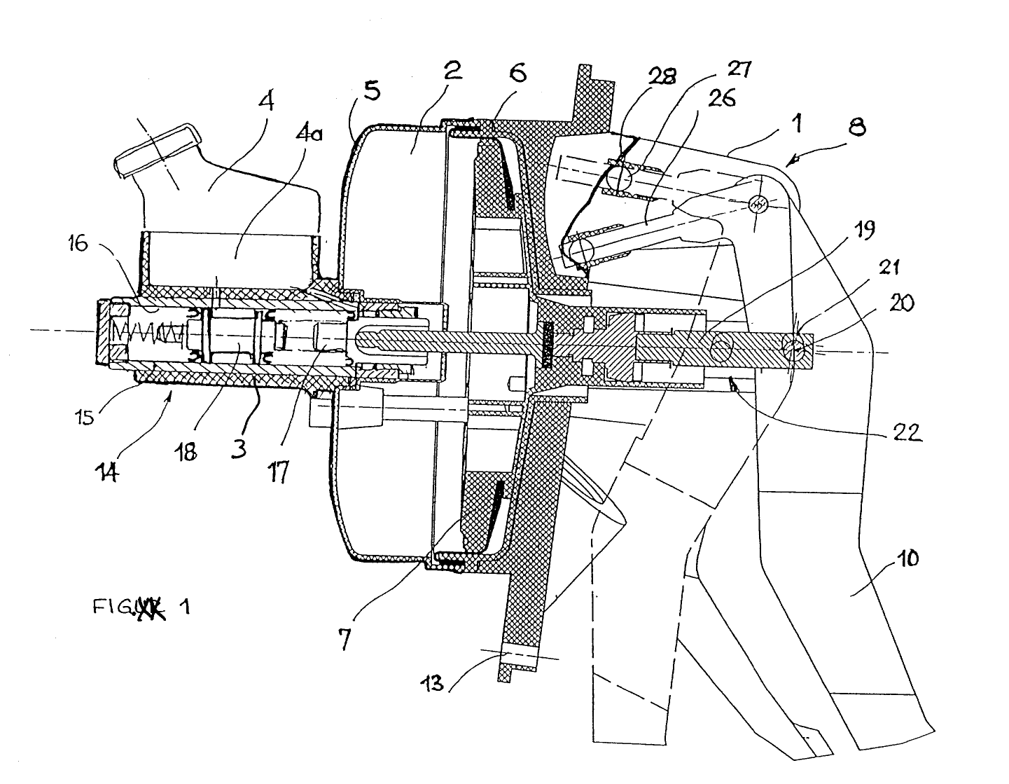

FIG. 1 also shows that a pin element 26, which is rigidly connected to the brake pedal 10, is made in one piece with the brake pedal 10 at the upper end of the brake pedal 10, adjacent to the mounting element. The pin element 26 is finger-shaped and has at its front, free end facing away from the brake pedal 10 at least one roller 27, which is pressed by a compression spring, not specifically shown, against a control cam 28 at the pedal block 1. Pivoting of the brake pedal 10 leads to the rolling of the roller 27 on the control cam 28 and, as a result, to a restoring moment, which varies depending on the pivoting angle, and, as a consequence of this, to a different feel of actuation for the brake pedal 10.

The shape of the control cam 28 in conjunction with the rolling effect of the roller 27 make possible the design adaptation of the brake pedal actuation and optimization of the feel of actuation.

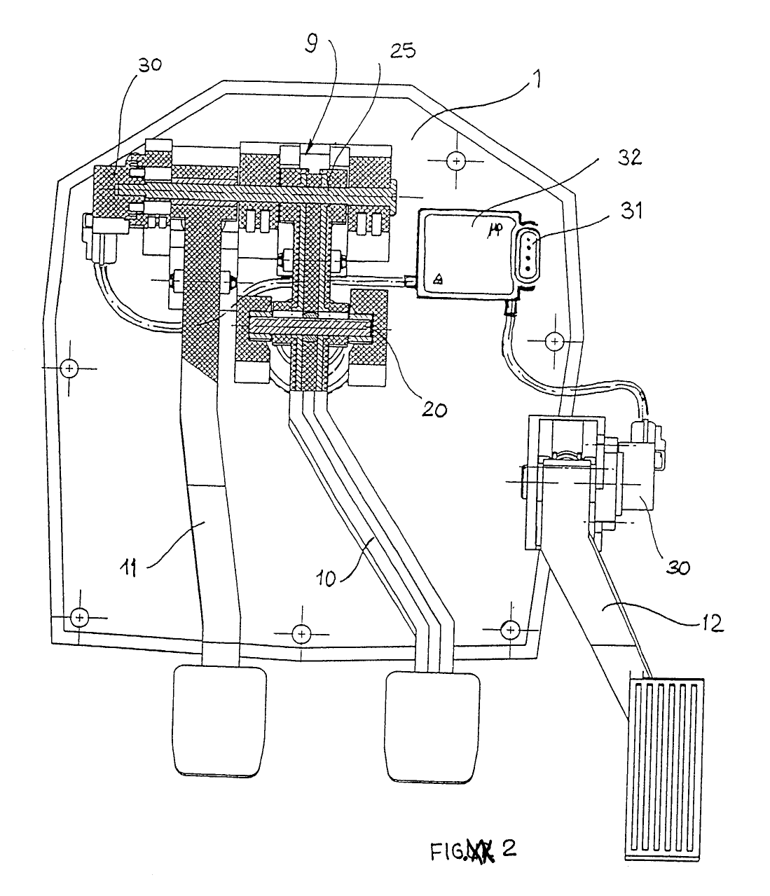

As is apparent from FIG. 2, the clutch pedal 11 and the brake pedal 10 are arranged pivotably on a common mounting axis 25, which contributes to a reduction in the number of individual parts as well as in the assembly efforts compared with conventional individual mounting.

Corresponding to another advantageous embodiment of the subject of the present invention, at least one Hall sensor or inductive sensor 30 is arranged at the pedal block 1 for the contactless signal pick-up for the angular position of the brake pedal. Such a sensor 30 may, of course, also be used for the contactless data transmission of the instantaneous position of a gas pedal 12, which is also illustrated in FIG. 2.

The signals received are transmitted by a central plug assembly unit 31, which transmits the signals to the motor vehicle electronic system via the intermediary of an evaluating assembly unit 32. The evaluating assembly unit 32 may be integrated according to the present invention in the pedal block (see FIG. 2) and convert the signals received via a CAN-BUS or a corresponding processor for the further processing within the motor vehicle electronic system.

The Hall sensors or inductive sensors 30 used are designed according to the present invention such that they replace the switches usually used in the prior art for tail lights, shift lock, a possibly existing brake assist and similar supplementary sensor elements.

Moreover, the fact that the brake booster housing is manufactured from plastic makes it possible to integrate supply lines 33 for admitting vacuum or ambient pressure into the interior space of the brake booster housing within the housing wall of the brake booster housing. FIG. 3 shows an embodiment variant according to the present invention with a two-stage brake booster (tandem brake booster), in which the supply lines are recessed in the housing. This measure leads to a further reduction in the assembly effort, especially in the case of two-stage brake boosters.

Thus, the drawings attached show clearly that the design according to the present invention leads to a compact actuating device for the brake system of a motor vehicle, in which the number of individual parts used is substantially reduced compared with the prior art and makes possible the pre-assembly of the entire assembly unit, including the final testing. The entire actuating device can be supplied completely to the motor vehicle assembly line and is fastened to the body of the motor vehicle only by means of the screws passed through the holes 13. In addition, only the connection of the brake lines to the master cylinder assembly unit 3 as well as the plugging of the plug assembly unit 31 to a corresponding receptacle on the body are necessary.

The compact design makes possible the use of a tandem brake booster wherever no place was hitherto available for such a two-stage brake booster because of the limited space available for installation in the engine compartment.

While specific embodiments of the invention have been shown and described in detail to illustrate the application of the principles of the invention, it will be understood that the invention may be embodied otherwise without departing from such principles.

1. Actuating device for the brake system of a motor vehicle with a said pedal block (1) with a said brake pedal (10) fixed thereon pivotably, with a said brake booster (2) with a housing having a said housing bottom part (6) and a said housing bell (5) and with a said master cylinder assembly unit (3) connected thereto for admitting hydraulic power into the individual wheel brakes of the motor vehicle, wherein the said pedal block (1) and the said housing bottom part (6) are molded in one piece from a plastic, characterized in that the said housing bell (5) and the said master cylinder assembly unit (3) having a said reservoir (4) with a said reservoir bottom (4a) and a said piston unit (14) is molded as a one-piece plastic part, and that a said hydraulic tube (15) jacketed by the plastic part for receiving the said individual brake pistons (17) is arranged within the said piston unit (14).

2. Actuating device in accordance with claim 1, characterized in that the part formed by the said housing bottom part (6) and the said pedal block (1) and the part formed by the said housing bell (5) and the said master cylinder assembly unit (3) are designed as an injection-molded plastic part each.

3. Actuating device in accordance with claim 1 or 2, characterized in that the said pedal block (1) has a said common mounting element (9) for mounting the said brake pedal (10) and a said additional clutch pedal (11).

4. Actuating device in accordance with one of the claims 1 through 3, characterized in that the said pedal block (1) has contactless sensors, preferably said Hall sensors (30) for picking up signals of the angular position of the said brake pedal (10) and of a said additional gas pedal (12), wherein the signal is transmitted to downstream evaluating assembly units of a motor vehicle electronic system by a said central plug assembly unit (31).

5. Actuating device in accordance with claim 4, characterized in that the said evaluating assembly unit (32) has a CAN-BUS for data conversion and is integrated in the said pedal block (1).

6. Actuating device in accordance with one of the claims 1 through 5, characterized in that the said pedal block (1) has at least one said control cam (28), on which a said spring-loaded roller (27) rigidly connected to the said brake pedal (10) rolls during the pivoting of the said brake pedal (10).

7. Actuating device in accordance with one of the claims 1 through 6, characterized in that the said brake booster (2) and the said master cylinder assembly unit (3) can be actuated via a said common push rod (19), wherein the said push rod (19) is mounted in the said pedal block (1) by means of a said straight guide (22) and is displaceably accommodated in a said elongated hole (21) at the said brake pedal (10).

8. Actuating device in accordance with one of the claims 1 through 7, characterized in that said supply lines (33) for admitting vacuum or ambient pressure to the interior space of the brake booster housing are integrated in the housing wall of the said brake booster housing (5, 6) made of plastic.
